(19) United States
(12) Patent Application Publication
(10) Pub. No.: US 2007/0022763 A1
(43) Pub. Date: Feb. 1, 2007

(54) Frozen beverages

(76) Inventor: Steven Moulder, Redditch (GB)

Correspondence Address: PYLE & PIONTEK, 221 N. LASALLE STREET,, SUITE 2036, CHICAGO, IL, 60601, US

(21) Appl. No.: 11/474,908

(22) Filed: Jun. 26, 2006

(30) Foreign Application Priority Data
Jun. 27, 2005 (GB) 0512966.3

(51) Int. Cl. F25C 1/00; A23G 9/00

(52) U.S. Cl. 62/135; 62/342

(57) ABSTRACT

Frozen beverages having a desired viscosity (consistency) are produced using a parameter representative of the change between unfrozen and frozen states of the beverage to control cooling of the beverage. The parameter may be the pressure or temperature of the beverage in a freeze cylinder 7 where circulation of coolant to cool the beverage is controlled by a control unit 14 in response to a pressure or temperature sensor 28.

### DISCLOSURE

This invention concerns improvements in or relating to frozen beverages and in particular to an apparatus and method for producing and/or dispensing frozen beverages. As used herein, the term “frozen” is used to describe beverages that are partially frozen that is, not forming a solid mass. Frozen beverages of this type are commonly referred to as “semi-frozen” or “slush” beverages that are capable of flowing and can be dispensed via a tap.

The invention has application to dispense of both alcoholic and non-alcoholic frozen beverages. The invention may be used to dispense both carbonated and non-carbonated (still) beverages and is especially suitable for dispense of frozen cider although it is not intended to be limited to such application.

### BACKGROUND OF THE INVENTION

Apparatus for producing frozen beverages is well known and typically includes a freeze cylinder comprising a beverage chamber in which liquid beverage is converted to frozen beverage by simultaneously cooling and stirring the beverage to achieve a desired viscosity (consistency). In the known apparatus, stirring is carried out mechanically by rotating an agitator driven by an electric motor.

Cooling and thus viscosity (consistency) of the frozen beverage is controlled in response to the resistance encountered by the agitator. More especially, as the beverage freezes, the viscosity of the frozen beverage increases and this in turn increases the torque that must be applied to rotate the agitator. This increase in torque can be used to control the cooling and thus the viscosity of the frozen beverage.

In one known arrangement, the motor is pivotally mounted and increased resistance to rotation of the agitator as the beverage freezes causes the motor to pivot against the biasing of a spring. The spring biasing is chosen so that the motor can pivot sufficiently to operate a switch to stop the cooling system when the frozen beverage has the required viscosity.

In another known arrangement, the motor is provided with means to detect increased resistance to rotation of the agitator as the beverage freezes and stop the cooling system when the frozen beverage has the required viscosity. Such means may be a motor current sensor and feedback loop.

In the known arrangements, the torque transmitted through the agitator is relied on to monitor viscosity (consistency) of the frozen beverage and control beverage cooling. The motor and controls are expensive and limited in range. In addition, there are problems associated with the accuracy and reliability of such arrangements.

For example, there is no set relationship between viscosity and torque and the nature of the frozen beverage can vary dramatically at any given torque value. As a result, the beverage can be subjected to cooling in excess of that required to achieve the desired viscosity. This in turn adds to costs and has an adverse effect on the quality of the frozen beverage.

In particular, the viscosity (consistency) of beverages containing water is related to the ice structure that is formed as the beverage freezes. Excessive cooling can lead to the ice crystal structure continuing to grow, becoming larger and sharper and reducing the ability of the frozen beverage to flow. This is referred to as the “Ostwald” ripening effect.

Operation of the cooling system to provide cooling over and above that required can also result in lumps of frozen beverage forming on the agitator reducing the resistance to rotation.

### SUMMARY OF THE INVENTION

The present invention has been made from a consideration of the foregoing problems and disadvantages of the known systems for dispensing frozen beverages.

Thus, it is an object of the present invention to provide an improved apparatus and method for producing and/or dispensing frozen beverages.

According to a first aspect of the present invention, there is provided apparatus for producing a frozen beverage comprising a freeze cylinder having a beverage chamber, cooling means for cooling beverage in the beverage chamber to produce a frozen beverage, monitoring means for monitoring a parameter of the beverage in the beverage chamber, and control means for controlling operation of cooling means in response to the monitoring means.

The phase change that occurs when a beverage containing water freezes is accompanied by changes in physical parameters of the beverage such as pressure and temperature. By monitoring one or both of these the cooling means can be controlled to achieve and maintain a frozen beverage having a desired viscosity (consistency).

More especially, liquid (unfrozen) beverages that contain water expand (increase in volume) as they freeze. This expansion leads to an increase in the pressure of the beverage in the beverage chamber that is related to the change from the liquid to the frozen state. This increase in pressure also causes a temperature change to occur that is related to the change from the liquid to the frozen state. This relationship between the pressure and temperature and the change of state of the beverage can be used to control the cooling means to achieve and maintain a frozen beverage having a desired viscosity (consistency).

In particular, the rapid pressure and temperature changes that occur as the beverage changes between liquid (unfrozen) and frozen states can be used to provide close control of the cooling means to achieve and maintain the desired viscosity (consistency) in a simple, cost effective manner that reduces or eliminates the afore-mentioned problems of the known control systems.

In one arrangement, the control means is operable to activate the cooling means in response to a pre-determined lower pressure in the beverage chamber and to de-activate the cooling means in response to a pre-determined upper pressure in the beverage chamber. Operating the cooling means between upper and lower pressure limits controls the cooling in an accurate, reliable manner that keeps cooling to that required to achieve and maintain the desired viscosity (consistency) of the frozen beverage. As a result, operating costs may be reduced and/or product quality improved. In particular, the “Ostwald” ripening effect may be controlled to prevent the ice crystal structure growing to form large, sharp crystals that inhibit flow of the frozen beverage.

Preferably, the control means can over-ride the upper pressure limit and operate the cooling means at pressures above the upper pressure limit under certain conditions. For example, over-shooting the upper pressure limit may be desirable on start-up of the apparatus and/or following a de-frost cycle when the beverage chamber is filled with liquid beverage. In this condition, the increase in pressure due to expansion caused as the beverage freezes may exceed the upper pressure limit before the beverage reaches a uniform frozen state having the desired viscosity. Once the uniform frozen state has been achieved, the control means reverts back to operate the cooling means at pressures between the upper and lower limits.

Any suitable pressure sensor such as a pressure transducer may be employed to monitor the pressure in the beverage chamber and provide a signal representative of the pressure to the control means for controlling operation of the cooling means. A single pressure sensor may be used to monitor the pressure in the beverage chamber. Alternatively a plurality of pressure sensors may be used to monitor the pressure at different positions and provide a signal representative of the average pressure sensed by all the pressure sensors. The or each pressure sensor may monitor the pressure in the beverage chamber directly or indirectly.

Preferably, the beverage chamber is provided with a pressure relief valve operable to open an outlet in response to the pressure in the beverage chamber exceeding a pre-determined pressure higher than the upper pressure limit controlling the cooling means. The pressure relief valve prevents the beverage chamber being subjected to pressures that may result in damage to the beverage chamber or parts of the freeze cylinder and control system.

The pressure at which the relief valve opens may be set sufficiently above the upper pressure limit for controlling the cooling system so as to open only in an emergency. In this way, the pressure in the beverage chamber can exceed the upper pressure limit without opening the relief valve and thereby reduce beverage loss through the relief valve.

Preferably, the freeze cylinder is provided with an accumulator (expansion chamber) that accommodates expansion of the frozen beverage. In this way, pressure changes in the beverage chamber may be damped to reduce the response of the apparatus to pressure changes.

In another arrangement, the control means is operable to control the cooling means in response to the beverage temperature. For example, alcoholic beverages containing water such as cider, beer, lager start to freeze under pressure at temperatures below 0° C., accompanied by an increase in temperature as freezing continues that is used to control the cooling means. Operating the cooling means in response to the temperature change when the beverage freezes, controls the cooling in an accurate, reliable manner that keeps cooling to that required to achieve and maintain the desired viscosity (consistency) of the frozen beverage. As a result, operating costs may be reduced and/or product quality improved. In particular, the “Ostwald” ripening effect may be controlled to prevent the ice crystal structure growing to form large, sharp crystals that inhibit flow of the frozen beverage.

Any suitable temperature sensor such as a thermistor may be employed to monitor the temperature in the beverage chamber and provide a signal representative of the temperature to the control means for controlling operation of the cooling means. A single temperature sensor may be used to monitor the temperature in the beverage chamber. Alternatively a plurality of temperature sensors may be used to monitor the temperature at different positions and provide a signal representative of the average temperature sensed by all the temperature sensors.

Any suitable cooling means may be employed to freeze beverage in the beverage chamber. In one arrangement, the beverage chamber is surrounded by a cooling jacket through which coolant is circulated to freeze the beverage in response to the pressure and/or temperature in the beverage chamber. The coolant may be a water/glycol mixture. Alternatively, the coolant may be a refrigerant where the cooling jacket comprises an evaporator of a refrigeration system.

Preferably, the beverage chamber is connectable to a dispense tap for dispensing frozen beverage. The tap may also be connectable to a source of liquid (unfrozen) beverage for dispense of beverages comprising either frozen beverage or liquid (unfrozen) beverage only or a mixture of frozen beverage and liquid (unfrozen) beverage. The frozen beverage and liquid (unfrozen) beverage may be the same or different.

According to a second aspect of the present invention, there is provided a method of producing a frozen beverage comprising providing a freeze cylinder having a beverage chamber and cooling means for freezing beverage in the beverage chamber, and controlling operation of the cooling means in response to a parameter of the beverage in the beverage chamber.

Preferably, the method includes controlling operation of the cooling means in response to change in pressure and/or temperature of the beverage in the beverage chamber.

Preferably, the method includes operating the cooling means to circulate coolant for freezing beverage in the beverage chamber.

Preferably, the method includes a de-frost cycle for converting frozen beverage to liquid (unfrozen) beverage. The de-frost cycle may be carried out during periods of low use and/or overnight to prevent or reduce the occurrence of ice lumping/compaction and/or Ostwald ripening in the beverage chamber.

Preferably, the method includes a start-up cycle for converting liquid (unfrozen) beverage to frozen beverage

Preferably, the method includes controlling the cooling means during the de-frost cycle in response to the temperature of liquid (unfrozen) beverage in the beverage chamber so as to maintain the beverage at a pre-determined temperature, for example a few degrees above freezing. In this way, deterioration of the beverage is prevented or reduced and the time required to re-freeze the beverage on start-up is reduced.

Preferably, the method includes dispensing frozen beverage from the beverage chamber and replacing beverage drawn off from the beverage chamber with liquid (unfrozen) beverage.

According to a third aspect of the present invention, there is provided a beverage dispense system incorporating the apparatus according to the first aspect of the invention.

Preferably, the system includes means for dispensing frozen beverage and liquid (unfrozen) beverage. The dispense means may comprise a tap having a first operative position for dispensing frozen beverage and a second operative position for dispensing liquid (unfrozen) beverage.

According to a fourth aspect of the present invention, there is provided a method of dispensing a frozen beverage comprising freezing beverage in a beverage chamber by the method according to the second aspect of the invention, and dispensing frozen beverage withdrawn from the beverage chamber.

According to a fifth aspect of the present invention, there is provided a beverage dispense system comprising a beverage source, a beverage supply line for supplying liquid (unfrozen) beverage from the beverage source to a dispense tap, a beverage supply line for supplying liquid (unfrozen) beverage from a beverage source to a freeze cylinder having a beverage chamber for freezing the beverage and supplying frozen beverage from the beverage chamber to a dispense tap, and means for controlling freezing of the beverage in the beverage chamber in response to a parameter of the beverage in the beverage chamber.

Preferably, the beverage supply lines are connected to a common beverage source and dispense tap for dispensing liquid (unfrozen) and frozen forms of the same beverage.

According to a sixth aspect of the present invention, there is provided apparatus for producing a frozen beverage comprising a beverage chamber, cooling means for cooling beverage in the beverage chamber to produce a frozen beverage, and control means for controlling operation of cooling means in response to pressure and/or temperature in the beverage chamber.

According to a seventh aspect of the present invention, there is provided a method of producing a frozen beverage comprising providing a beverage chamber and cooling means for freezing beverage in the beverage chamber, and controlling operation of the cooling means in response to pressure and/or temperature in the beverage chamber.

According to an eighth aspect of the present invention, there is provided a beverage dispense system comprising a beverage source, a beverage supply line for supplying liquid (unfrozen) beverage from the beverage source to a dispense tap, a beverage supply line for supplying liquid (unfrozen) beverage from a beverage source to a beverage chamber for freezing the beverage and supplying frozen beverage from the beverage chamber to a dispense tap, and means for controlling freezing of the beverage in the beverage chamber in response to pressure and/or temperature of beverage in the beverage chamber.

### BRIEF DESCRIPTION OF THE DRAWINGS

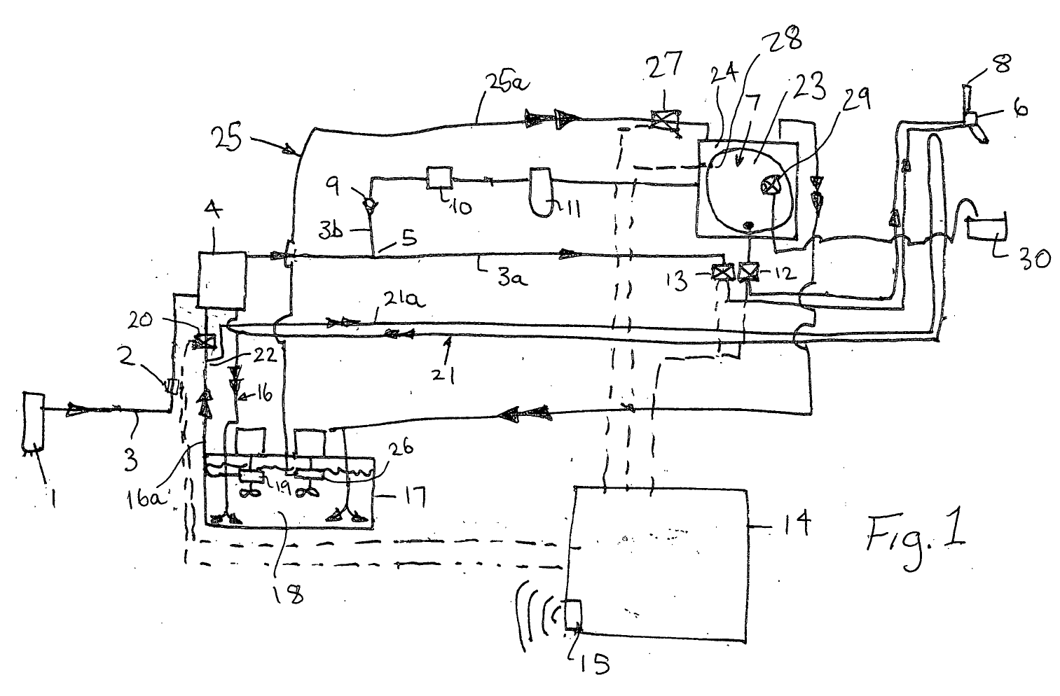

The invention will now be described in more detail by way of example only with reference to the accompanying drawing wherein the single FIG. 1 is a schematic illustration of a beverage dispense system embodying the invention in which beverage lines are indicated by single headed arrows and coolant lines by double headed arrows.

### DESCRIPTION OF THE INVENTION

The beverage dispense system shown in the drawing has a fob detector 1 and flow sensor 2 in the beverage line 3 from a beverage source (not shown) to one side of a plate heat exchanger 4. In this embodiment, the beverage is cider and the beverage source is a keg. It will be understood, however, that the invention includes other alcoholic and non-alcoholic beverages which may contain dissolved gas such as carbon dioxide or nitrogen referred to herein for convenience as carbonated beverages or uncarbonated (still) beverages.

The beverage line 3 from the plate heat exchanger 4 splits into two lines 3a,3b at a tee 5. One line 3a passes to a manually operable dispense tap 6 for dispense of liquid (unfrozen) cider. The other line 3b passes to a freeze cylinder 7 for converting liquid cider to frozen cider. The beverage line 3b from the freeze cylinder 7 passes to the dispense tap 6 for dispense of frozen cider.

The dispense tap 6 has a handle 8 that is pivotal from an upright, closed position to either one of two open positions. In one open position, the tap dispenses liquid (unfrozen) cider and in the other open position, the tap dispenses frozen cider. This type of dispense tap forms the subject matter of our co-pending European patent application No. 1669322. It will be understood that any other suitable type of dispense tap may be employed.

As will be understood, the dispense tap 6 can be operated to dispense cider in either form into a vessel such as a glass (not shown) placed under the tap 6. This allows the glass to be filled either with cider in one form only or with a mixture of both forms. Where a mixture is dispensed the frozen cider typically floats on the surface of the liquid (unfrozen) cider.

The beverage line 3b to the freeze cylinder 7 is provided with a check valve 9, a pressure regulator 10, and an accumulator 11. The check valve 9 prevents backflow of frozen cider into the line 3a. The pressure regulator 10 reduces the pressure of liquid (unfrozen) cider delivered to the freeze cylinder 7 to approximately 30 psi. The accumulator 11 accommodates expansion of frozen cider in the freeze cylinder 7.

The beverage line 3b from the freeze cylinder 7 to the dispense tap 6 is provided with a solenoid valve 12 and a solenoid valve 13 is also provided in the beverage line 3a downstream of the tee 5. Both solenoid valves 12,13 are connected to a control box 14 and are normally held open to allow dispense of liquid (unfrozen) cider or frozen cider when the dispense tap 6 is opened.

The fob detector 1 detects when the keg needs to be replaced and generates a wireless radio signal that is transmitted to a transceiver 15 at the control box 14 to close the solenoid valves 12,13 so that the beverage lines 3,3a,3b between the fob detector 1 and the solenoid valves 12,13 remain filled with cider while the keg is being changed.

As a result, gas used to propel the cider from the keg through the beverage lines 3,3a,3b is prevented from entering the beverage lines 3,3a,3b and the cider remaining in the lines 3,3a,3b does not de-gas to cause fobbing. In this way, the beverage lines 3,3a,3b and freeze cylinder 7 are filled with cider while the keg is changed and the system is ready to dispense cider after changing the keg without re-priming to remove gas/fob from the beverage lines which is wasteful of cider. This type of beverage saver system forms the subject matter of our co-pending UK Patent Application No. 2404651.

The other side of the plate heat exchanger 4 is connected to a re-circulation loop 16 for circulating coolant from a cooler 17 to reduce the temperature of the cider flowing through the heat exchanger 4 during dispense. In this embodiment, the coolant is a glycol/water mixture at a temperature of approximately −7.5° C. but it will be understood that the invention is not limited thereto and that other coolants and/or coolant temperatures may be employed according to the system requirements.

The coolant is circulated through the loop 16 from a reservoir 18 by means of a combined pump and agitator 19 located in the reservoir 18. The coolant line 16a to the plate heat exchanger 4 includes a solenoid valve 20 connected to the control box 14. The flow sensor 2 in the beverage line 3 is also connected to the control box 14.

The flow sensor 2 detects flow of cider in the beverage line 3 when the dispense tap 6 is opened causing the solenoid valve 20 to open and allow full flow of coolant through the heat exchanger 4 to cool the cider to a desired temperature for delivery to either the dispense tap 6 via line 3a or the freeze cylinder 7 via line 3b according to the form of the cider being dispensed.

The flow sensor 2 detects when the dispense is completed causing the solenoid valve 20 to close and prevent full flow of coolant through the heat exchanger 4 that could result in freezing of the cider remaining in the heat exchanger 4 between dispenses. The control box 14 includes a timer circuit that is operable to open periodically the solenoid valve 20 for a short period of time, for example a few seconds, to provide a flow of coolant through the heat exchanger 4 to prevent the cider remaining in the heat exchanger 4 warming up to any appreciable extent between dispenses.

A branch line 21a is connected to the coolant line 16a at a tee 22 upstream of the solenoid valve 20 and the heat exchanger 4 to provide flow of coolant through a branch loop 21. The branch loop 21 is arranged to provide cooling for the beverage lines 3a,3b to the dispense tap 6 to maintain the desired temperature of the cider in these lines during and between dispenses. The branch loop 21 may also provide cooling of a counter top fitting such as a font (not shown) for the dispense tap 6 to produce condensation or ice on the outside of the fitting. The branch loop 21 comprises a capillary tube of small diameter that provides a restricted flow of coolant sufficient to provide the required cooling without freezing beverage in the beverage lines 3,3a.

The freeze cylinder 7 has a sealed pressure chamber 23 also referred to herein as a beverage chamber that contains the cider and is surrounded by a cooling jacket 24 connected to a re-circulation loop 25 for circulating coolant from the cooler 17 to reduce the temperature of the cider in the chamber 23 sufficiently to convert the liquid (unfrozen) cider to frozen cider in the chamber 23. A beater (not shown) is mounted for rotation in the chamber 23 and has arms for agitating/stirring the cider in the chamber 23 and blades for scraping frozen cider from the inner surface of the chamber 23. The beater is rotated by a motor (not shown) and may be operated continuously while the apparatus is in use.

The coolant is circulated through the loop 25 from the reservoir 18 by means of a combined pump and agitator 26 located in the reservoir 18. The coolant line 25a to the cooling jacket 24 includes a solenoid valve 27 connected to the control box 14. The freeze cylinder 7 is provided with a sensor 28 for monitoring a parameter of the cider that can be used to detect the change in state between unfrozen (liquid) and frozen cider. The sensor 28 is also connected to the control box 14.

In this embodiment, the sensor 28 is a pressure sensor, for example a pressure transducer, for monitoring the pressure of the cider in the chamber 23. In a modification (not shown) the pressure sensor may be located in the beverage line 3b downstream of the non-return valve 9, for example between the accumulator 11 and the beverage chamber 23. In another embodiment, the sensor 28 is a temperature sensor, for example a thermistor, for monitoring the temperature of the cider in the chamber 23.

Cider in the chamber 23 is cooled by coolant circulating through the cooling jacket 24 when the solenoid valve 27 is open causing liquid (unfrozen) cider to be converted to frozen cider resulting in an increase in volume and hence an increase in pressure within the chamber 23. We have found that the increase in pressure is related to the viscosity (consistency) of the frozen cider produced in the chamber 23 and this is used to control the cooling process to achieve and maintain a desired viscosity (consistency) of frozen cider in the chamber 23.

The pressure changes rapidly according to the viscosity (consistency) of the frozen cider and we have found that this can be used to provide close control of the cooling process to achieve and maintain the desired viscosity (consistency) of the frozen cider in the chamber 23.

More specifically, circulation of coolant through the cooling jacket 24 to cool cider in the chamber 23 is allowed until the pressure reaches a pre-determined upper limit at which the solenoid valve 27 is closed and the solenoid valve 27 remains closed until the pressure falls to a pre-determined lower limit at which the solenoid valve 27 is opened.

In this embodiment, we have found that we can achieve and maintain the desired viscosity (consistency) of frozen cider during operation of the freeze cylinder 7 by controlling cooling between an upper limit of 38 psi and a lower limit of 36 psi. It will be understood, however, that the invention is not limited to these pressures and that the upper and lower limits may be altered according to the type of beverage to be dispensed and/or the desired viscosity of the beverage to be dispensed.

During periods of low use and/or overnight, a stand-by or de-frost cycle is activated that allows the frozen beverage to warm-up sufficiently to convert frozen beverage to liquid (unfrozen) beverage. This inhibits the occurrence of ice lumping/compaction and/or Ostwald ripening in the chamber 23. During the de-frost cycle, coolant is circulated through the cooling jacket 24 in response to the temperature of the beverage in the chamber 23 to maintain the beverage temperature a few degrees above freezing. In this way, the time required to re-freeze the beverage is reduced allowing the apparatus to recover quickly to produce frozen beverage for dispense.

On start-up or after a defrost cycle, the chamber 23 contains liquid (unfrozen) cider under pressure that fills the chamber 23 leaving no headspace of gas above the cider in the chamber 23. As a result, the change of state from liquid to frozen cider that occurs when the beverage starts to freeze can result in a sudden increase in pressure within the chamber 23 causing the upper pressure limit to be reached and the solenoid valve 27 closed to stop cooling before a uniform desired viscosity (consistency) of frozen cider is achieved within the chamber 23. Accordingly, the control box includes an over-ride circuit that allows the pressure in the chamber 23 to overshoot the upper pressure limit to achieve the desired viscosity (consistency) and then re-instate the upper pressure limit to control cooling between the upper and lower limits.

The chamber 23 is provided with a pressure relief valve 29 that opens in response to the pressure in the chamber 23 exceeding a pre-determined pressure higher than the upper pressure limit and discharges frozen cider to a drip tray 30 under the dispense tap 6 to reduce the pressure in the chamber 23. The pressure at which the relief valve 29 opens may be set sufficiently above the upper pressure limit for controlling beverage cooling so as to open only in an emergency. In this way, the pressure in the chamber 23 can exceed the upper pressure limit without opening the relief valve 29 and thereby reduce beverage loss through the relief valve 29.

Operation of the freeze cylinder 7 will now be described starting from the condition in which the chamber 23 contains frozen cider of the desired viscosity (consistency) and the solenoid valve 27 is closed. If the tap 6 is opened to dispense frozen cider, the pressure in the chamber 23 drops to the pressure in line 3b, typically about 18 psi, and frozen cider exiting the chamber 23 is replaced by liquid (unfrozen) cider.

The drop in pressure causes the solenoid valve 27 to open to circulate coolant through the jacket 24 while the liquid (unfrozen) cider is converted to frozen cider causing the pressure in the chamber 23 to rise until the upper limit of 38 psi is reached at which the frozen cider in the chamber 23 has the desired viscosity (consistency) and the solenoid valve 27 is closed. In this way, the cooling system responds to start cooling when frozen cider is dispensed and replaced by liquid (unfrozen) cider. As a result, the liquid (unfrozen) cider is converted to frozen cider having the desired viscosity (consistency).

Between dispenses, the pressure in the freeze cylinder 7 may gradually decay as frozen cider starts to melt until the pressure reaches the lower limit of 36 psi at which the solenoid valve 27 is opened to circulate coolant through the jacket 24 until the pressure increases to the upper limit of 38 psi and the solenoid valve 27 is closed. In this way, the desired viscosity (consistency) of the frozen cider can be maintained between dispenses by simple control of the cooling system in response to the pressure in the chamber 23.

Operation of the freeze cylinder 7 when the sensor 28 is a temperature sensor will now be described. On start-up or following de-frost, the chamber 23 contains liquid (unfrozen) cider having a temperature above 0° C. The control unit 14 opens solenoid valve 27 and coolant is circulated through the cooling jacket 24 to cool the cider to about minus 6° C. at which point the cider starts to freeze. The phase change as the cider starts to freeze is accompanied by an increase in temperature of the frozen cider to about minus 3° C.

The temperature change is detected by the temperature sensor 28 and the control unit 14 is operable to control circulation of coolant through the cooling jacket 24 to maintain the temperature of the frozen beverage at this level. If the temperature increases, for example if unfrozen (liquid) cider is added to the chamber 23 to replace frozen cider dispensed from tap 6, the control unit 14 opens solenoid valve 27 to circulate coolant through the cooling jacket 24 to freeze the cider.

We have found that the increase in temperature when the cider starts to freeze under pressure is related to the viscosity (consistency) of the frozen cider produced in the chamber 23 and this is used to control the cooling process to achieve and maintain a desired viscosity (consistency) of frozen cider in the chamber 23. In this embodiment, we have found that we can achieve and maintain the desired viscosity (consistency) of frozen cider during operation of the freeze cylinder 7 by controlling cooling at about minus 3° C. It will be understood, however, that the invention is not limited thereto and that the temperature may be altered according to the type of beverage to be dispensed and/or the desired viscosity of the beverage to be dispensed

As will now be understood, monitoring the pressure or temperature in the chamber 23 to control the cooling applied to the chamber 23 is simple and provides greater control of the cooling. In particular, cooling in excess of that required is reduced or eliminated which inhibits growth of the ice crystal structure. As a result, the “Ostwald” ripening effect and ice compacting/lumping is reduced. In this way, the invention enables the viscosity (consistency) of the frozen cider to be controlled more accurately leading to improved product quality.

It will be appreciated that the invention is not limited to the embodiment above-described and includes all improvements and modifications that can be made without departing from the principles or concepts described herein. For example we may monitor both pressure and temperature of the beverage in the chamber to control operation of the cooling means.

Although the invention has been described for the production of frozen cider, it will be understood that pressure and/or temperature control of the freeze cylinder may be used to produce other types of alcoholic frozen beverages such as beer, lager, cocktails as well as non-alcoholic frozen beverages such as colas, fruit juices and the invention includes any type of beverage capable of being frozen for dispense.

What is claimed is:

1. Apparatus for producing a frozen beverage comprising a freeze cylinder having a beverage chamber, cooling means for cooling beverage in the beverage chamber to produce a frozen beverage, monitoring means for monitoring a parameter of the beverage in the beverage chamber, and control means for controlling operation of the cooling means in response to the monitoring means.

2. Apparatus according to claim 1 wherein the monitoring means is a pressure sensor.

3. Apparatus according to claim 1 wherein the monitoring means is a temperature sensor.

4. Apparatus according to claim 1 wherein the monitoring means comprises a pressure sensor and a temperature sensor.

5. Apparatus according to claim 2 wherein, the control means is operable to activate the cooling means in response to a pre-determined lower pressure in the beverage chamber and to de-activate the cooling means in response to a pre-determined upper pressure in the beverage chamber.

6. Apparatus according to claim 5 wherein, the control means can over-ride the upper pressure limit and operate the cooling means at pressures above the upper pressure limit.

7. Apparatus according to claim 2 wherein, the pressure sensor is arranged to monitor the pressure in the beverage chamber and provide a signal representative of the pressure to the control means for controlling operation of the cooling means.

8. Apparatus according to claim 2 wherein, a plurality of pressure sensors is used to monitor the pressure in the beverage chamber at different positions and provide a signal representative of the average pressure sensed by all the pressure sensors.

9. Apparatus according to claim 3 wherein, the temperature sensor is arranged to monitor the temperature in the beverage chamber and provide a signal representative of the temperature to the control means for controlling operation of the cooling means.

10. Apparatus according to claim 9 wherein, a plurality of temperature sensors is used to monitor the temperature in the beverage chamber at different positions and provide a signal representative of the average temperature sensed by all the temperature sensors.

11. Apparatus according to claim 5 wherein, the beverage chamber is provided with a pressure relief valve operable to open an outlet in response to the pressure in the beverage chamber exceeding a pre-determined pressure higher than the upper pressure limit controlling the cooling means.

12. Apparatus according to claim 11 wherein, the control means can over-ride the upper pressure limit and operate the cooling means at pressures above the upper pressure limit and below the pressure at which the relief valve opens.

13. Apparatus according to claim 1 wherein, the freeze cylinder is provided with an accumulator (expansion chamber) that accommodates expansion of the frozen beverage.

14. Apparatus according to claim 1 wherein, the beverage chamber is surrounded by a cooling jacket through which coolant is circulated to freeze the beverage.

15. Apparatus according to claim 14 wherein, the coolant is a water/glycol mixture.

16. Apparatus according to claim 14 wherein, the coolant is a refrigerant and the cooling jacket comprises an evaporator of a refrigeration system to freeze the beverage.

17. Apparatus according to claim 1 wherein, the beverage chamber is connectable to a dispense tap for dispensing frozen beverage.

18. Apparatus according to claim 17 wherein the tap is connectable to a source of liquid (unfrozen) beverage for dispense of beverages selected from the group comprising frozen beverage or liquid (unfrozen) beverage only or a mixture of frozen beverage and liquid (unfrozen) beverage.

19. A method of producing a frozen beverage comprising providing a freeze cylinder having a beverage chamber and cooling means for freezing beverage in the beverage chamber, and controlling operation of the cooling means in response to a parameter of the beverage in the beverage chamber.

20. A method according to claim 19 further comprising the step of controlling operation of the cooling means in response to the pressure of the beverage in the beverage chamber.

21. A method according to claim 19 further comprising the step of controlling operation of the cooling means in response to the temperature of the beverage in the beverage chamber.

22. A method according to claim 19 further comprising controlling operation of the cooling means in response to the pressure and temperature of the beverage in the beverage chamber.

23. A method according to claim 20 further comprising the step of controlling operation of the cooling means between upper and lower pressures.

24. A method according to claim 19 further comprising the step of operating the cooling means to circulate coolant for freezing beverage in the beverage chamber.

25. A method according to 19 further comprising a start-up cycle for converting liquid (unfrozen) beverage to frozen beverage.

26. A method according to claim 19 further comprising a de-frost cycle for converting frozen beverage to liquid (unfrozen) beverage

27. A method according to claim 26 further comprising the step of controlling the cooling means during the de-frost cycle in response to the temperature of liquid (unfrozen) beverage in the beverage chamber so as to maintain the beverage at a pre-determined temperature, for example a few degrees above freezing.

28. A method according to claim 20 further comprising the step of dispensing frozen beverage from the beverage chamber and replacing beverage drawn off from the beverage chamber with liquid (unfrozen) beverage.

29. A beverage dispense system comprising a beverage source, a beverage supply line for supplying liquid (unfrozen) beverage from the beverage source to a dispense tap, a beverage supply line for supplying liquid (unfrozen) beverage from a beverage source to a freeze cylinder having a beverage chamber for freezing the beverage and supplying frozen beverage from the beverage chamber to a dispense tap, and means for controlling freezing of the beverage in the beverage chamber in response to a parameter of the beverage in the beverage chamber.

30. A beverage dispense system according to claim 29 wherein the control means is responsive to pressure of the beverage in the beverage chamber.

31. A beverage dispense system according to claim 29 wherein the control means is responsive to temperature of the beverage in the beverage chamber.

32. A beverage dispense system according to claim 29 wherein the beverage supply lines are connected to a common beverage source and dispense tap for dispensing liquid (unfrozen) and frozen forms of the same beverage.
